(19) United States
(12) Patent Application Publication
(10) Pub. No.: US 2013/0040276 A1
(43) Pub. Date: Feb. 14, 2013

(54) ILLUMINATION DEVICE AND INFORMATION PROCESSING DEVICE

(71) Applicants: Junya Takakura, Tokyo (JP); Yoshie Imai, Tokyo (JP); Toshimitsu Kaneko, Kanagawa (JP)

(72) Inventors: Junya Takakura, Tokyo (JP); Yoshie Imai, Tokyo (JP); Toshimitsu Kaneko, Kanagawa (JP)

(73) Assignee: KABUSHIKI KAISHA TOSHIBA, Tokyo (JP)

(21) Appl. No.: 13/561,493

(22) Filed: Jul. 30, 2012

(30) Foreign Application Priority Data
Aug. 12, 2011 (JP) 2011-177168

(51) Int. Cl. G09B 7/00

(52) U.S. Cl. 434/335

(57) ABSTRACT

According to an embodiment, an illumination device includes a light source whose emission intensity is controllable; an identifying unit configured to identify an activity of a user; and a light source controller configured to control the emission intensity of the light source so that a level of arousal of the user becomes lower than a predetermined level when the identified activity is a learning activity representing an activity to form a memory in the brain of the user.

### CROSS-REFERENCE TO RELATED APPLICATIONS

This application is based upon and claims the benefit of priority from Japanese Patent Application No. 2011-177168, filed on Aug. 12, 2011; the entire contents of which are incorporated herein by reference.

### FIELD

Embodiments described herein relate generally to an illumination device and an information processing device.

### BACKGROUND

In related art, it has been known that light sources such as backlights, fluorescent lights, light bulbs and light emitting diodes (LEDs) provided on back faces of displays mounted on various terminals have influence on the level of arousal of users. In one aspect, the level of arousal of users is higher as light contains shorter wavelength components having wavelengths around 460 nm (nanometer), that is, as light has higher color temperature. Accordingly, in learning attempting to memorize more information in the brain or the like, a light source having high color temperature is provided in some cases so as to increase the level of arousal of users.

With the related art, however, there is a possibility that the effects of learning are decreased. In general, it is known that exposure to a light that increases the level of arousal has influence on sleep afterwards such as causing trouble getting to sleep and light sleep. Moreover, it is also known that sleep in high quality is more preferable for storing what have been learned in the brain for a longer period of time. In other words, since the quality of sleep is not at all considered in the related art although the quality of sleep and the maintenance of memory are correlated with each other, there is a possibility that the effects of learning are decreased.

### BRIEF DESCRIPTION OF THE DRAWINGS

FIG. 1 is a block diagram illustrating an exemplary configuration of an illumination device according to a first embodiment;

FIG. 2 is a diagram illustrating an example of an operation input by a user;

FIG. 3 is a flowchart illustrating an example of a flow of a control process according to the first embodiment;

FIG. 4 is a diagram illustrating an example of a user interface connected to an identifying unit;

FIG. 5 is a flowchart illustrating an example of a flow of a control process according to a modified example of the first embodiment;

FIG. 6 is a flowchart illustrating an example of a flow of a control process according to a modified example of the first embodiment;

FIG. 7 is a block diagram illustrating an exemplary configuration of an identifying unit according to a second embodiment;

FIG. 8 is a flowchart illustrating an example of a flow of a control process according to the second embodiment;

FIG. 9 is a block diagram illustrating an exemplary configuration of an illumination device according to a third embodiment;

FIG. 10 is a flowchart illustrating an example of a flow of a control process according to the third embodiment;

FIG. 11 is a block diagram illustrating an exemplary configuration of an illumination device according to a fourth embodiment;

FIG. 12 is a flowchart illustrating an example of a flow of a control process according to the fourth embodiment;

FIG. 13 is a block diagram illustrating an exemplary configuration of an illumination device according to a fifth embodiment;

FIG. 14 is a flowchart illustrating an example of a flow of a control process according to the fifth embodiment;

FIG. 15 is a block diagram illustrating an exemplary configuration of an illumination device according to a sixth embodiment;

FIG. 16 is a block diagram illustrating an exemplary configuration of an estimation unit according to the sixth embodiment;

FIG. 17 is a flowchart illustrating an example of a flow of a control process according to the sixth embodiment;

FIG. 18 is a diagram illustrating an example of an object illuminated with illumination light containing a plurality of colors;

FIG. 19 is a block diagram illustrating an exemplary configuration of an illumination device according to a seventh embodiment;

FIG. 20 is a block diagram illustrating an exemplary configuration of an estimation unit according to the seventh embodiment;

FIG. 21 is a diagram illustrating an exemplary configuration of an input section according to the seventh embodiment;

FIG. 22 is a diagram illustrating an exemplary configuration of an input section according to a modified example of the seventh embodiment; and

FIG. 23 is a block diagram illustrating an exemplary configuration of an information processing device.

### DETAILED DESCRIPTION

According to an embodiment, an illumination device includes a light source whose emission intensity is controllable; an identifying unit configured to identify an activity of a user; and a light source controller configured to control the emission intensity of the light source so that a level of arousal of the user becomes lower than a predetermined level when the identified activity is a learning activity representing an activity to form a memory in the brain of the user.

### First Embodiment

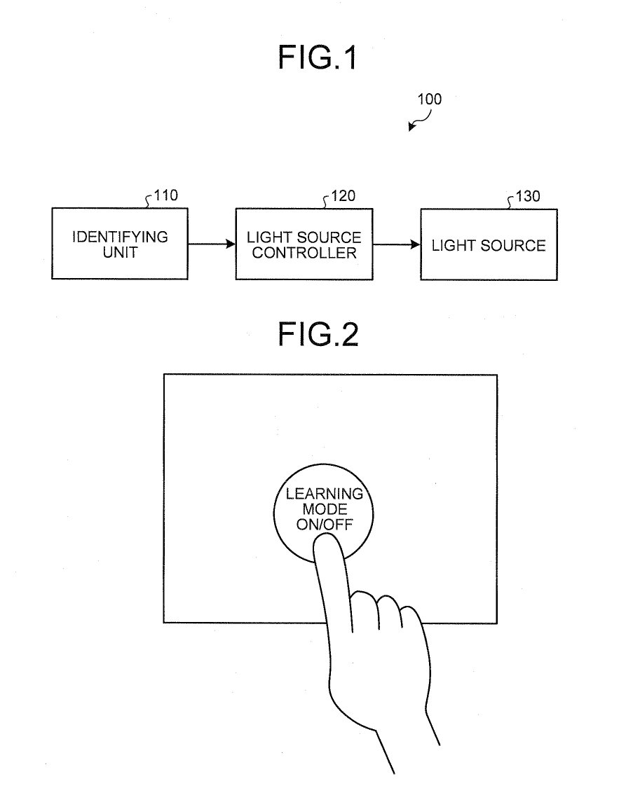

FIG. 1 is a block diagram illustrating an exemplary configuration of an illumination device according to a first embodiment. As illustrated in FIG. 1, for example, an illumination device 100 includes an identifying unit 110, a light source controller 120 and a light source 130.

The identifying unit 110 receives an operation input from a user, and identifies the activity of the user on the basis of the received input, for example. FIG. 2 is a diagram illustrating an example of the operation input by the user. As illustrated in FIG. 2, for example, the user performs an operation to turn a learning mode “ON” for performing a learning activity representing an activity to form a memory in the brain of the user. A user interface used for the operation input of turning the learning mode “ON/OFF” illustrated in FIG. 2 is a physical button, a touch panel or the like and is connected to the identifying unit 110. Note that a state in which the learning mode is “OFF” may be referred to as an initial setting mode.

Such a user interface does not have to display “learning” but may display “study”, “homework”, “self-development” or the like, or may display a pictogram or a predetermined icon corresponding thereto. Specifically, when the identifying unit 110 receives an input for turning the learning mode “ON” from the user interface, the identifying unit 110 identifies the activity mode as the learning mode since the activity by the user is a learning activity. When the identifying unit 110 receives an input for turning the learning mode “OFF” from the user interface, on the other hand, the identifying unit 110 identifies the activity mode as the initial setting mode since the activity by the user is not a learning activity.

The light source controller 120 controls the emission intensity of the light source 130 so that the level of arousal of the user becomes lower than a predetermined level when the activity by the user identified by the identifying unit 110 is a learning activity, for example. Specifically, the light source controller 120 has a given memory into which a set control amount for the light source 130 for each activity mode is stored. When the activity mode is identified as the learning mode by the identifying unit 110, the light source controller 120 obtains a set control amount associated with the learning mode from the memory, and controls the light source 130 with the obtained set control amount. When the activity mode is identified as the initial setting mode by the identifying unit 110, on the other hand, the light source controller 120 obtains a set control amount associated with the initial mode from the memory, and controls the light source 130 with the obtained set control amount.

The set control amount associated with the learning mode is a set value at which the level of arousal of the user becomes lower than the predetermined level, and, in one aspect, at which the emission intensity is decreased by 30% of a default value. The control of the light source 130 by the light source controller 120 may be control of the amount of current flowing through light emitting elements of the light source 130 or control of voltage applied to the light emitting elements of the light source 130. The method for the control may be any method such as pulse width modulation (PWM) control or phase control.

The light source 130 includes one or more light emitting elements whose emission intensities can be controlled independently, for example. Alternatively, the light source 130 may include a plurality of light emitting elements with different spectral distributions. In this case, light emitted by the light source 130 has a color that is a mixture of respective colors of the light emitting elements. Examples of the light emitting elements include incandescent light bulbs, fluorescent tubes and LEDs. In addition, the light source 130 may further include a light diffuser or the like for mixing the colors of light from a plurality of light emitting elements. For example, if n types (n is an integer of 1 or larger) of light emitting elements are used and the spectral distribution of an i-th light emitting element is Pᵢ(λ), the spectral power distribution of the light source 130 is expressed by the following Expression (1).

$$P ( λ ) = {\sum }_{i = 1}^{n} {a}_{i} {P}_{i} ( λ ) \qquad ( 1 )$$

Note that making the level of arousal lower described above specifically refers to a condition corresponding to either reducing a value obtained by integration of a product of a melatonin secretion inhibiting spectrum and the spectral power distribution of the light source 130 or reducing a value of a prediction formula for melatonin secretion inhibition taking responses of cones, rods and ganglion cells containing melanopsin into account.

The value obtained by integration of a product of a action spectrum for meratonin suppression and the spectral power distribution of the light source 130 is defined by the following Expression (2) where the spectral power distribution of light energy emitted by the light source 130 is represented by P(λ) and the action spectrum for meratonin suppression is represented by M₁(λ).

∫_{380 nm}^{730 nm}Iₑ(λ)M₁(λ)dλ (2)

The prediction formula for melatonin secretion inhibition taking responses of cones, rods and ganglion cells containing melanopsin into account is obtained according to the following value of T (Expression (3)), and can be calculated by Expression (4) when T≧0 is satisfied and by Expression (5) when T<0 is satisfied.

$$\begin{matrix} T = {\int }_{380 nm}^{730 nm} P ( λ ) S ( λ ) d λ - k {\int }_{380 nm}^{730 nm} P ( λ ) {V}_{10} ( λ ) d λ & ( 3 ) \\ [ ( {α}_{1} {\int }_{380 nm}^{730 nm} P ( λ ) {M}_{2} ( λ ) d λ - {b}_{1} ) + {α}_{2} ( {\int }_{380 nm}^{730 nm} P ( λ ) S ( λ ) d λ - k {\int }_{380 nm}^{730 nm} P ( λ ) {V}_{10} ( λ ) d λ ) - {b}_{2} ] - {α}_{3} [ 1 - exp ( - \frac{{\int }_{380 nm}^{730 nm} P ( λ ) {V}^{′} ( λ ) d λ}{rodSat} ) ] & ( 4 ) \\ {α}_{1} {\int }_{380 nm}^{730 nm} P ( λ ) {M}_{2} ( λ ) d λ - {b}_{1} & ( 5 )\end{matrix}$$

In the expressions, constants are as follows: k=0.31, α=0.285, α₂=0.2, α₃=0.72, b₁=0.01, b₂=0.001, and rodSat=6.5. In addition, M₂(λ) represents the spectral reaction sensitivity of ganglion cells containing melanopsin, V₁₀(λ) represents the spectral reaction sensitivity of L-cones and M-cones, V′(λ) represents the spectral reaction sensitivity of rods and S(λ) represents the spectral reaction sensitivity of S-cones.

When the light source 130 includes one type of light emitting element, a decrease in the level of arousal (values of the above expressions) can be achieved by decreasing the emission intensity of the one type of light emitting element. When the light source 130 includes two or more types of light emitting elements, on the other hand, a decrease in the level of arousal can be achieved by making the proportion of the emission intensity of light emitting elements containing many components having wavelengths around 460 nm (blue) smaller than that of the other light emitting elements.

The reasons why the above expressions are used are as follows. For example, it is known that the secretion of hormone called melatonin is decreased when exposed to illumination light that increases the level of arousal. The melatonin is known to have various influences on bodies by acting on tissues containing melatonin receptors called MT1 and MT2. It is also known that melatonin receptors exist in human hippocampus that is a part involved in memory in the brain. It is also known that formation of memory is inhibited in a melatonin receptor deficient animal resulting from genetic modification. For these reasons, it is preferable to reduce a value obtained by integration of a product of a melatonin secretion inhibiting spectrum and the spectral power distribution of the light source 130 or to reduce a value of a prediction formula for melatonin secretion inhibition taking responses of cones, rods and ganglion cells containing melanopsin into account.

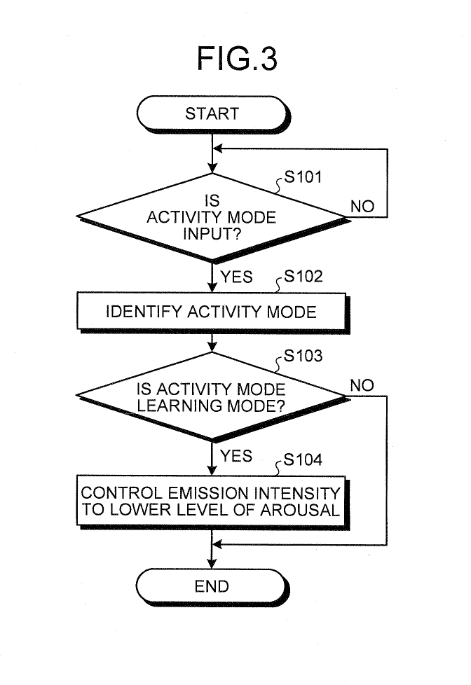

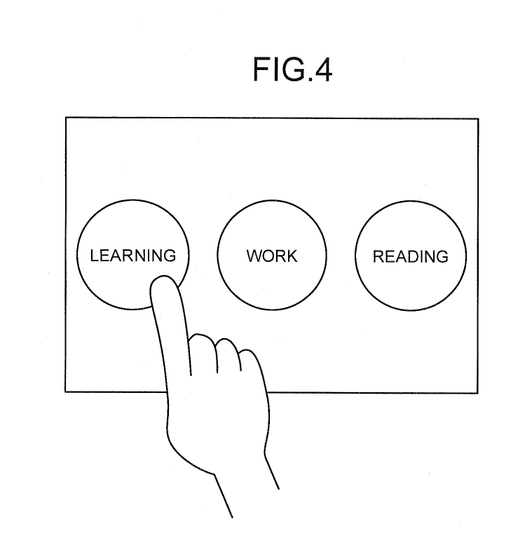

Next, a control process performed by the illumination device 100 according to the first embodiment will be described with reference to FIG. 3. FIG. 3 is a flowchart illustrating an example of a flow of the control process according to the first embodiment. The control process is performed, in one aspect, in a state in which illumination light from the light source 130 of the illumination device 100 is emitted.

As illustrated in FIG. 3, for example, when an activity mode is input from a predetermined user interface (Yes in step S101), the identifying unit 110 identifies the activity mode as the learning mode or the initial setting mode (step S102). When an activity mode is not input from a predetermined user interface (No in step S101), on the other hand, the identifying unit 110 enters a state waiting for an input of an activity mode from the predetermined user interface.

The light source controller 120 then determines whether or not the activity mode identified by the identifying unit 110 is the learning mode (step S103). If the light source controller 120 determines that the activity mode identified by the identifying unit 110 is the learning mode (Yes in step S103), the light source controller 120 controls the emission intensity of the light source 130 so that the level of arousal of the user becomes lower than a predetermined level (step S104).

The set control amount used for control on the light source 130 is stored in a given memory, and the set amount associated with the learning mode is set so that the level of arousal of the user becomes lower as compared to the set amount associated with the initial setting mode. On the other hand, if the light source controller 120 determines that the activity mode identified by the identifying unit 110 is the initial setting mode (No in step S103), the light source controller 120 terminates the process.

According to the first embodiment, since the emission intensity of the light source is controlled so that the level of arousal of the user becomes lower when the activity of the user is a learning activity, it is possible to suppress the influence on sleep of the user afterwards and increase the learning effects.

### Modified Example 1 of First Embodiment

The activity mode is not limited to either of the learning mode and the initial setting mode, but a plurality of activity modes may be provided in addition. FIG. 4 is a diagram illustrating an example of a user interface connected to the identifying unit 110.

As illustrated in FIG. 4, for example, the user interface is capable of setting a plurality of activity modes such as “work” and “reading” in addition to “learning”. Accordingly, the identifying unit 110 receives an input of a learning mode, a work mode or a reading mode, and identifies the activity mode for the user. The light source controller 120 controls the light source 130 at the emission intensity associated with the activity mode identified by the identifying unit 110. For example, the set value of the emission intensity in the work mode is set so that the level of arousal becomes higher as compared to the learning mode. Alternatively, the activity modes may further include a “sleep mode” or the like in which the level of arousal becomes lower than the learning mode. The set value for each activity mode is stored in a given memory.

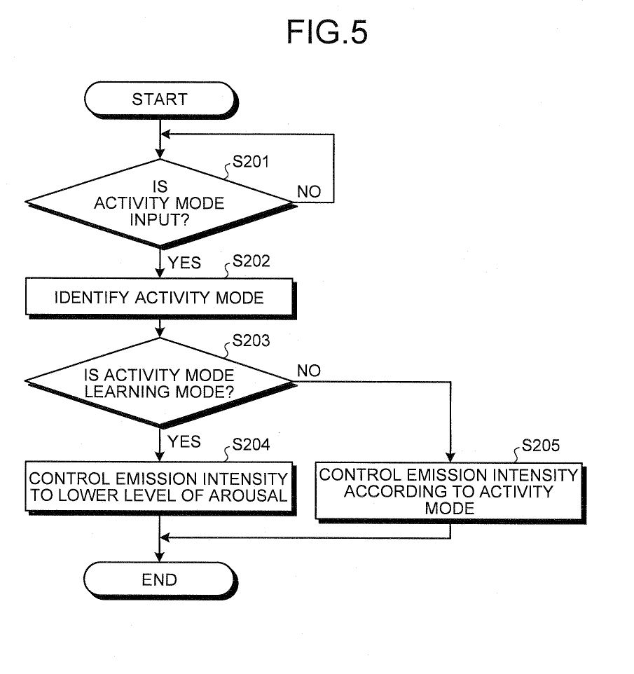

Next, a control process performed by the illumination device 100 according to the modified example of the first embodiment will be described with reference to FIG. 5. FIG. 5 is a flowchart illustrating an example of a flow of the control process according to the modified example of the first embodiment.

As illustrated in FIG. 5, for example, when an activity mode is input from a predetermined user interface (Yes in step S201), the identifying unit 110 identifies the activity mode as one of a plurality of activity modes (step S202). When an activity mode is not input from the predetermined unit (No in step S201), on the other hand, the identifying unit 110 enters a state waiting for an input of an activity mode from the predetermined user interface.

The light source controller 120 then determines whether or not the activity mode identified by the identifying unit 110 is the learning mode (step S203). If the light source controller 120 determines that the activity mode identified by the identifying unit 110 is the learning mode (Yes in step S203), the light source controller 120 controls the emission intensity of the light source 130 so that the level of arousal of the user becomes lower than a predetermined level (step S204). If the light source controller 120 determines that the activity mode identified by the identifying unit 110 is an activity mode other than the learning mode (No in step S203), the light source controller 120 controls the emission intensity of the light source 130 to be a set control amount associated with the activity mode (step S205).

According to this modified example, it is possible to control the emission intensity of the light source 130 according to the activity of the user such as an activity for which it is preferable to keep a relatively high level of arousal or, on the contrary, an activity for which it is preferable to keep a relatively low level of arousal, and it is possible to suppress the influence on sleep of the user afterwards and increase the learning effects when the activity of the user is a learning activity.

### Modified Example 2 of First Embodiment

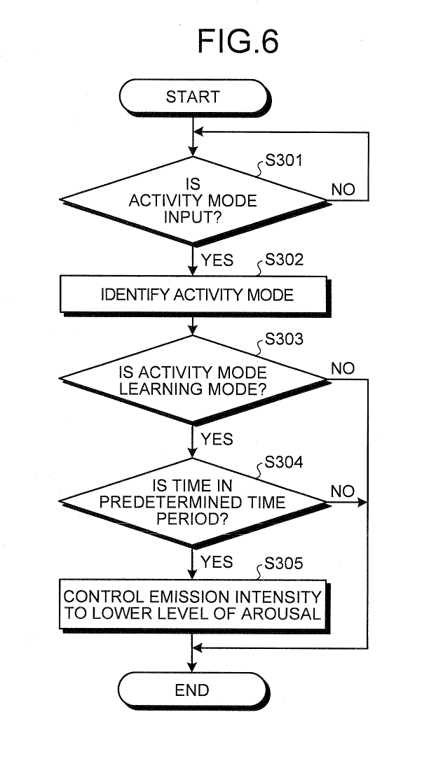

Alternatively, it may be determined whether or not the light source controller 120 controls the emission intensity of the light source 130 according to times of the day. Specifically, the light source controller 120 includes a timer (not illustrated) that keeps time, and performs processes according to the time period of the time obtained from the timer. FIG. 6 is a flowchart illustrating an example of a flow of the control process according to the modified example of the first embodiment.

As illustrated in FIG. 6, for example, when an activity mode is input from a predetermined user interface (Yes in step S301), the identifying unit 110 identifies whether the activity mode is the learning mode or the initial setting mode (step S302). When an activity mode is not input from the predetermined user interface (No in step S301), on the other hand, the identifying unit 110 enters a state waiting for an input of an activity mode from the predetermined user interface.

The light source controller 120 then determines whether or not the activity mode identified by the identifying unit 110 is the learning mode (step S303). If the light source controller 120 determines that the activity mode identified by the identifying unit 110 is the learning mode (Yes in step S303), the light source controller 120 obtains the time from the timer and determines whether or not the obtained time is in a predetermined time period (step S304). On the other hand, if the light source controller 120 determines that the activity mode identified by the identifying unit 110 is the initial setting mode (No in step S303), the light source controller 120 terminates the process.

If the light source controller 120 determines that the obtained time is in the predetermined time period (Yes in step S304), the light source controller 120 controls the emission intensity of the light source 130 so that the level of arousal of the user becomes lower than a predetermined level (step S305). On the other hand, if the light source controller 120 determines that the obtained time is not in the predetermined time period (No in step S304), the light source controller 120 terminates the process.

The predetermined time period is, in one aspect, a time period between 18 o'clock in the evening around the time of sunset and 6 o'clock in the morning around the time of sunrise. The predetermined time period may be arbitrarily set on the basis of the lifestyle of the user or the like.

According to this modified example, since the emission intensity of the light source is controlled so that the level of arousal is kept high when learning is performed during a time period such as in the early morning or in the daytime when the light have little influence on sleep at night and that the level of arousal is kept low when learning is performed during a time period from the evening till night when light have much influence on sleep at night, it is possible to increase the learning effects.

### Second Embodiment

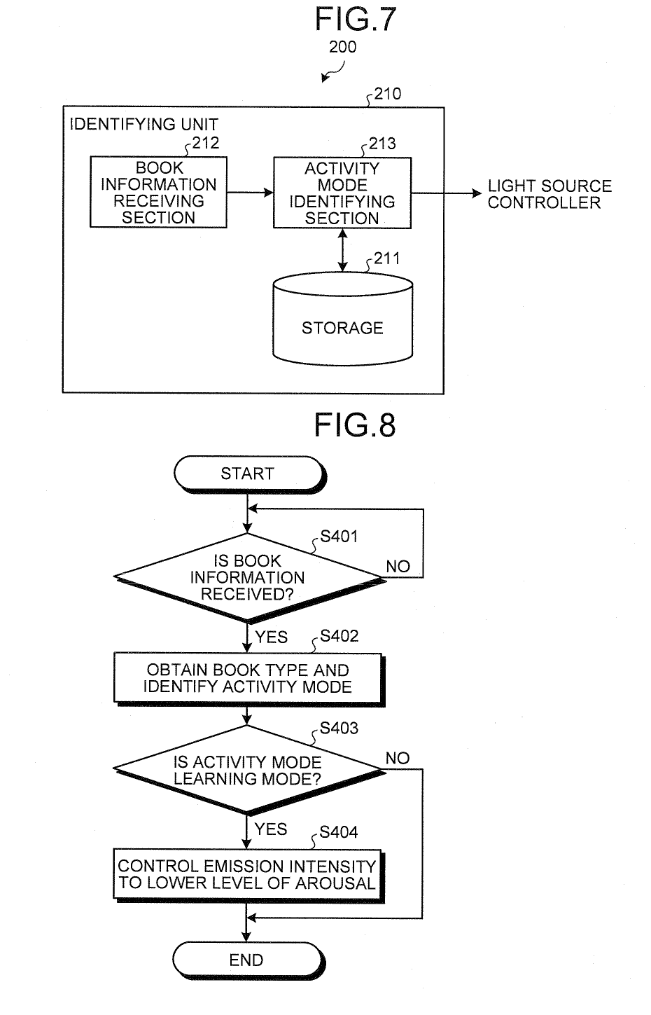

FIG. 7 is a block diagram illustrating an exemplary configuration of an identifying unit according to a second embodiment. In the second embodiment, the following reference numerals will be used for describing the device and the functional units: an illumination device 200, an identifying unit 210, a light source controller 120 and a light source 130. That is, the functional units that perform processes similar to those in the first embodiment will be designated by the same reference numerals and the description of the same processes may not be repeated.

As illustrated in FIG. 7, for example, the identifying unit 210 includes a storage 211, a book information receiving section 212 and an activity mode identifying section 213. The storage 211 stores therein the type of a book in association with book information identifying the book, for example. The book information is information capable of identifying the type of books such as an international standard book number (ISBN) code, a C code or a book name. The type of book is information capable of identifying whether the book is of a learning type. The storage 211 does not have to be included in the illumination device 200 and may exist on a network such as the Internet, for example.

The C code is a four-digit number in which the first digit represents a targeted buyer, the second digit represents a form of the book, and the third and fourth digits represent content of the book. For example, a first digit “6” represents a study guide for elementary and junior high school student, and a first digit “7” represents a study guide for high school students. Accordingly, the activity mode identifying section 213 can identify whether or not the book in question is of a learning type by referring to the storage 211.

The book information receiving section 212 receives the book information such as an ISBN code, a C code or a book name, and informs the activity mode identifying section 213 of the same, for example. The book information receiving section 212 may be a bar-code reader or a camera, or may be an interface that receives input of a book ID input by an activity of the user.

The activity mode identifying section 213 obtains the type of the book corresponding to the book information informed by the book information receiving section 212 from the storage 211, for example. The activity mode identifying section 213 then identifies the activity mode of the user on the basis of the obtained book type, for example. For the identification of the activity mode, the activity mode identifying section 213 uses a table holding information on whether or not the book type corresponds to the learning mode. In the case where the storage 211 exists on a network such as the Internet, the activity mode identifying section 213 has a function for accessing the network.

Next, a control process performed by the illumination device 200 according to the second embodiment will be described with reference to FIG. 8. FIG. 8 is a flowchart illustrating an example of a flow of the control process according to the second embodiment.

As illustrated in FIG. 8, for example, when the book information receiving section 212 receives book information (Yes in step S401), the activity mode identifying section 213 obtains the book type associated with the book information from the storage 211 and identifies the activity mode of the user on the basis of the obtained book type (step S402). For the identification of the activity mode, the table holding information on whether or not the book type corresponds to the learning mode is used.

The light source controller 120 determines whether or not the activity mode identified by the identifying unit 210 is the learning mode (step S403). If the light source controller 120 determines that the activity mode identified by the identifying unit 210 is the learning mode (Yes in step S403), the light source controller 120 controls the emission intensity of the light source 130 so that the level of arousal of the user becomes lower than a predetermined level (step S404). On the other hand, if the light source controller 120 determines that the activity mode identified by the identifying unit 210 is the initial setting mode (No in step S403), the light source controller 120 terminates the process.

According to the second embodiment, since the determination of whether an activity is a learning activity is appropriately made on the basis of the book type and the emission intensity of the light source is controlled even when the user himself/herself does not recognize that the activity is a learning activity, it is possible to suppress the influence on sleep of the user afterwards and increase the learning effects.

### Third Embodiment

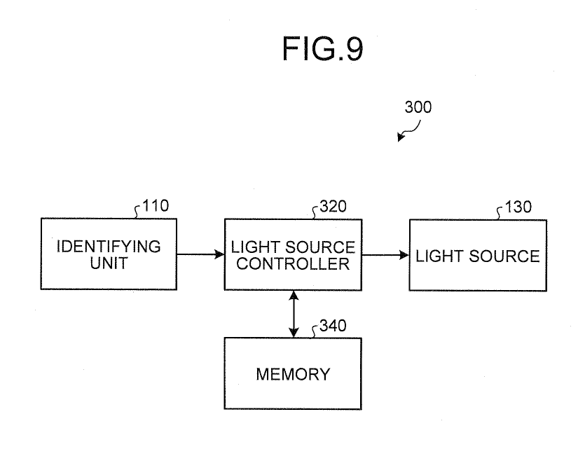

FIG. 9 is a block diagram illustrating an exemplary configuration of an illumination device according to a third embodiment. In FIG. 9, the functional units that perform processes similar to those in the first embodiment will be designated by the same reference numerals and the description of the same processes may not be repeated.

As illustrated in FIG. 9, for example, an illumination device 300 includes an identifying unit 110, a light source controller 320, a light source 130 and a memory 340. The memory 340 holds history information indicating that the user has performed a learning activity for a predetermined period of time. The predetermined period of time does not necessarily refer to 24 o'clock of the day but is preferably determined on the basis of the lifestyle cycle of the user. For example, the predetermined period of time may be set to 4 o'clock in the morning or may be set to the time at which the illumination device 300 is turned off after 24 o'clock. The memory 340 also registers/holds the time at which the history information is registered together with the history information so as to hold the history information for the predetermined period of time.

The light source controller 320 controls the emission intensity of the light source 130 so that the level of arousal of the user becomes lower than a predetermined level if the activity mode identified by the identification identifying unit 110 is not a learning mode and if the history information is held in the memory 340, for example.

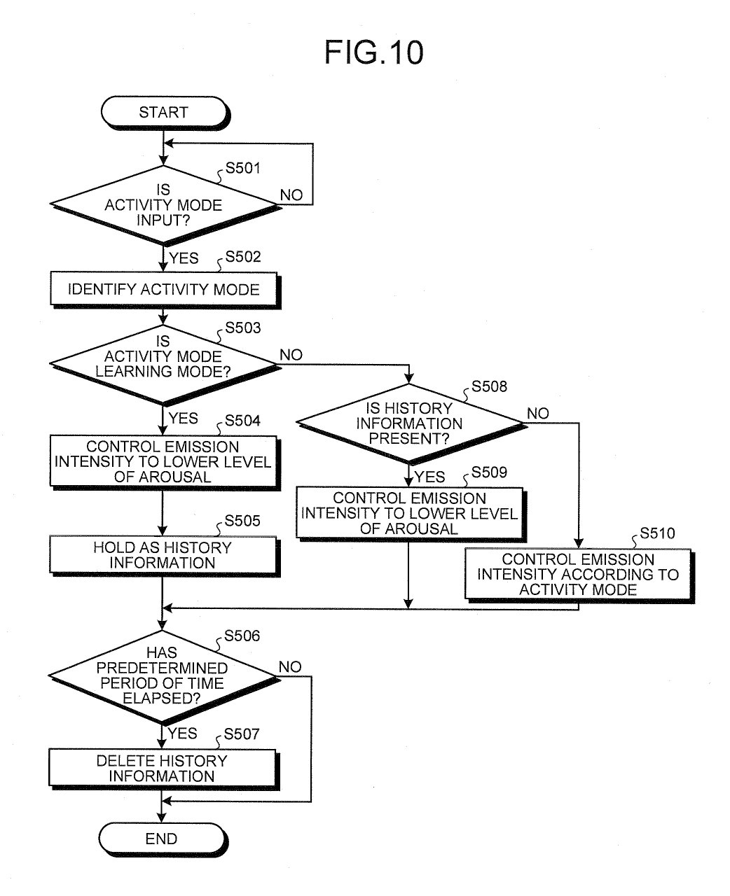

Next, a control process performed by the illumination device 300 according to the third embodiment will be described with reference to FIG. 10. FIG. 10 is a flowchart illustrating an example of a flow of the control process according to the third embodiment.

As illustrated in FIG. 10, for example, when an activity mode is input from a predetermined user interface (Yes in step S501), the identifying unit 110 identifies whether the activity mode is the learning mode or another mode (step S502). When an activity mode is not input from a predetermined user interface (No in step S501), on the other hand, the identifying unit 110 enters a state waiting for an input of an activity mode from the predetermined user interface.

The light source controller 320 then determines whether or not the activity mode identified by the identifying unit 110 is the learning mode (step S503). If the light source controller 320 determines that the activity mode identified by the identifying unit 110 is the learning mode (Yes in step S503), the light source controller 320 controls the emission intensity of the light source 130 so that the level of arousal of the user becomes lower than a predetermined level (step S504).

At this time, the memory 340 registers/holds history information representing the learning mode, that is, indicating that the learning activity has been performed (step S505). Thereafter, when the memory 340 determines that the predetermined time period has elapsed (Yes in step S506), the memory 340 deletes the held history information (step S507). If the memory 340 determines that the predetermined time period has not elapsed (No in step S506), the memory 340 terminates the process.

If the light source controller 320 determines that the activity mode identified by the identifying unit 110 is not the learning mode (No in step S503), the light source controller 320 determines whether or not history information is present in the memory 340 (step S508). If the history information is present (Yes in step S508), the light source controller 320 controls the emission intensity of the light source 130 so that the level of arousal of the user becomes lower than a predetermined level (step S509). If the history information is not present (No in step S508), the light source controller 320 controls the emission intensity of the light source 130 with a set control amount associated with the activity mode (step S510). Subsequently, the processing in steps S506 and S507 described above is performed.

According to the third embodiment, since the emission intensity of the light source is controlled with the influence on sleep of the user afterwards taken into account if the learning is performed within the day even if the activity mode is not the learning mode, it is possible to increase the learning effects. Alternatively, in the third embodiment, when the history information is held by the memory 340, the identifying unit 110 may determine that the activity of the user is a learning activity and the emission intensity of the light source 130 may be controlled on the basis of the determination by the identifying unit 110.

### Fourth Embodiment

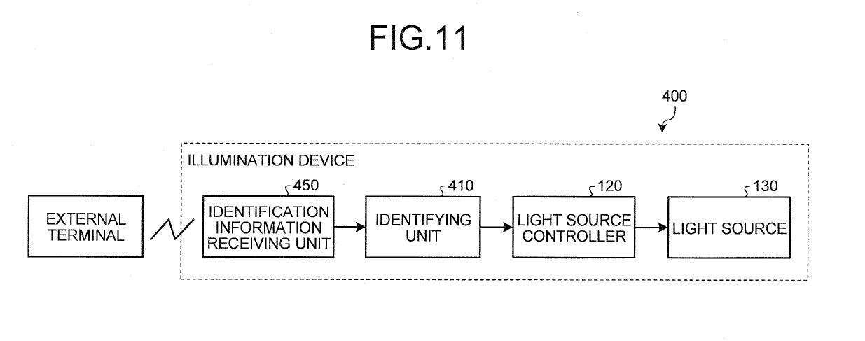

FIG. 11 is a block diagram illustrating an exemplary configuration of an illumination device according to a fourth embodiment. In FIG. 11, the functional units that perform processes similar to those in the first embodiment will be designated by the same reference numerals and the description of the same processes may not be repeated.

As illustrated in FIG. 11, for example, an illumination device 400 includes an identifying unit 410, a light source controller 120, a light source 130 and an identification information receiving unit 450. The illumination device 400 is capable of communicating with an external terminal having a communication function such as a mobile phone, a smart phone, a tablet personal computer (PC), and a PC.

On such an external terminal, various types of application software can be run, for example. Examples of the application software includes learning software having functions of vocabulary lists and setting various problems and work software for performing works such as creating spreadsheets and documents. The external terminal also informs the illumination device 400 by using the communication function that various types of application software is running thereon.

The identification information receiving unit 450 receives identification information capable of identifying the type of application software run on the external terminal by the user, for example. The identification information is, in one aspect, information representing a genre to which application software (such as learning software) belongs. Means for communication between the external terminal and the identification information receiving unit 450 may be a wireless local area network (LAN), infrared communication, visible light communication, a universal serial bus (USB), or any other means.

The identifying unit 410 identifies an activity of the user on the basis of identification information received by the identification information receiving unit 450, for example. Specifically, the identifying unit 410 obtains an activity mode associated with the information of the genre to which the application software belongs from a table in which the genre and the activity mode are associated with each other, and identifies the activity mode of the user.

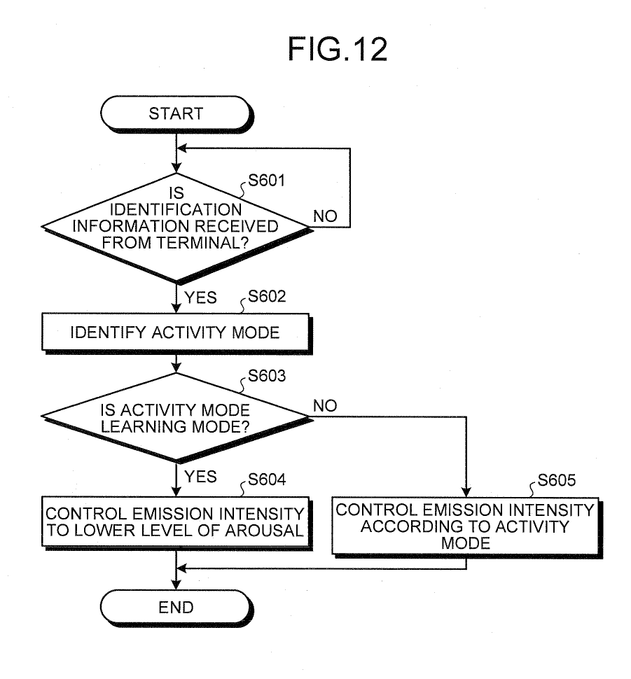

Next, a control process performed by the illumination device 400 according to the fourth embodiment will be described with reference to FIG. 12. FIG. 12 is a flowchart illustrating an example of a flow of the control process according to the fourth embodiment.

As illustrated in FIG. 12, for example, when the identification information receiving unit 450 receives identification information from an external terminal (Yes in step S601), the identifying unit 410 obtains the activity mode associated with the identification information from a predetermined table and identifies the activity mode of the user (step S602). If the identification information receiving unit 450 has not received identification information from an external terminal (No in step S601), a state waiting for identification information is entered. The light source controller 120 determines whether or not the activity mode identified by the identifying unit 410 is the learning mode (step S603).

If the light source controller 120 determines that the activity mode identified by the identifying unit 410 is the learning mode (Yes in step S603), the light source controller 120 controls the emission intensity of the light source 130 so that the level of arousal of the user becomes lower than a predetermined level (step S604). If the light source controller 120 determines that the activity mode identified by the identifying unit 410 is an activity mode other than the learning mode (No in step S603), the light source controller 120 controls the emission intensity of the light source 130 to be a set control amount associated with the activity mode (step S605).

According to the fourth embodiment, since the user need not input an activity mode, it is possible to avoid errors in selection of the activity mode or forgetting to set the activity mode and to increase the learning effects of the user.

### Fifth Embodiment

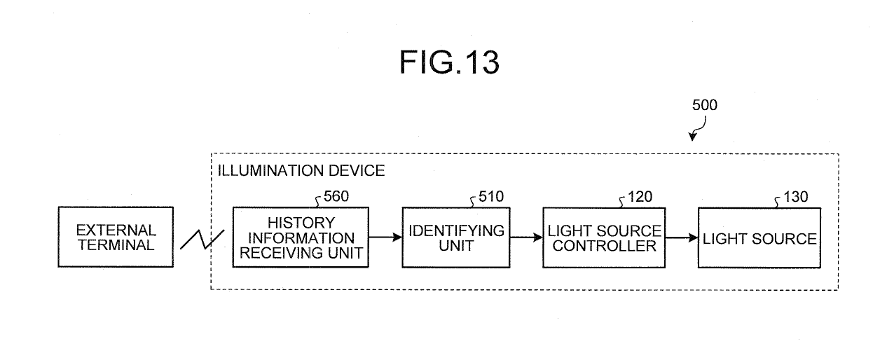

FIG. 13 is a block diagram illustrating an exemplary configuration of an illumination device according to a fifth embodiment. In FIG. 13, the functional units that perform processes similar to those in the first embodiment will be designated by the same reference numerals and the description of the same processes may not be repeated.

As illustrated in FIG. 13, for example, an illumination device 500 includes an identifying unit 510, a light source controller 120, a light source 130 and a history information receiving unit 560. The illumination device 500 is capable of communicating with an external terminal having a communication function such as a mobile phone, a smart phone, a tablet PC, and a PC.

Such an external terminal records history information indicating whether or not the user has performed a learning activity during a day, and informs the illumination device 500 by using the communication function of the history information. Whether the learning activity has been performed may be recorded on the basis of whether or not learning software has been run on the external terminal, may be recorded on the basis of whether or not the user has stayed at school or cram school determined using a positioning system such as a global positioning system (GPS) mounted on the external terminal, or may be recorded on the basis of a schedule registered in scheduling software on the external terminal.

The history information receiving unit 560 receives the history information indicating that the user has performed a learning activity from the external device, and stores the received history information. Means for communication between the external terminal and the history information receiving unit 560 may be a wireless LAN, infrared communication, visible light communication, a USB) or any other means.

The identifying unit 510 identifies the activity of the user on the basis of the history information received by the history information receiving unit 560. Specifically, when the history information of a learning activity is stored by the history information receiving unit 560, the identifying unit 510 identifies the activity mode of the user as the learning mode.

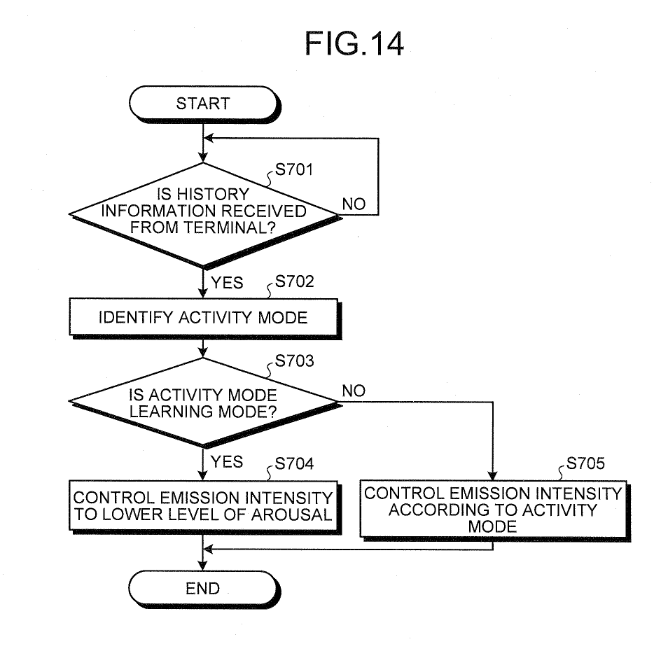

Next, a control process performed by the illumination device 500 according to the fifth embodiment will be described with reference to FIG. 14. FIG. 14 is a flowchart illustrating an example of a flow of the control process according to the fifth embodiment.

As illustrated in FIG. 14, for example, when the history information receiving unit 560 receives history information from an external terminal (Yes in step S701), the identifying unit 510 obtains identifies the activity mode associated with the history information (step S702). If the history information receiving unit 560 has not received history information from an external terminal (No in step S701), a state waiting for history information is entered. The light source controller 120 determines whether or not the activity mode identified by the identifying unit 510 is the learning mode (step S703).

If the light source controller 120 determines that the activity mode identified by the identifying unit 510 is the learning mode (Yes in step S703), the light source controller 120 controls the emission intensity of the light source 130 so that the level of arousal of the user becomes lower than a predetermined level (step S704). If the light source controller 120 determines that the activity mode identified by the identifying unit 510 is an activity mode other than the learning mode (No in step S703), the light source controller 120 controls the emission intensity of the light source 130 to be a set control amount associated with the activity mode (step S705).

According to the fifth embodiment, since the user need not input an activity mode, it is possible to avoid errors in selection of the activity mode or forgetting to set the activity mode and to increase the learning effects of the user. Moreover, according to the fifth embodiment, it is possible to reduce the influence of light caused by the illumination device 500 after the time of learning even if the learning performed by the user is not under the illumination device 500, and it is possible to increase the learning effects.

### Sixth Embodiment

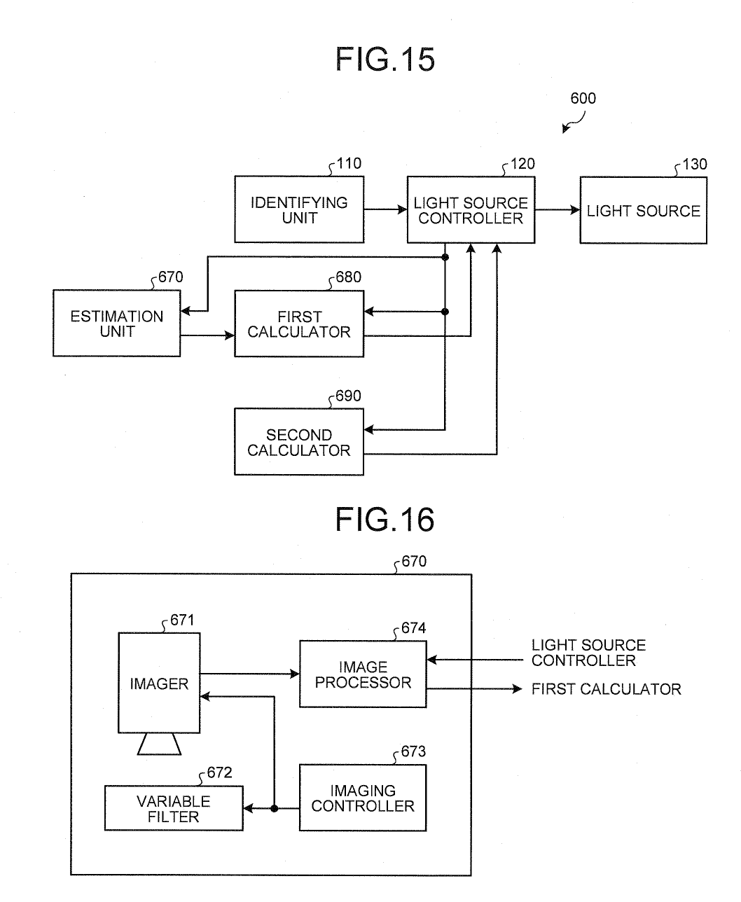

FIG. 15 is a block diagram illustrating an exemplary configuration of an illumination device according to a sixth embodiment. In FIG. 15, the functional units that perform processes similar to those in the first embodiment will be designated by the same reference numerals and the description of the same processes may not be repeated.

As illustrated in FIG. 15, for example, an illumination device 600 includes an identifying unit 110, a light source controller 120, a light source 130, an estimation unit 670, a first calculator 680 and a second calculator 690. The light source 130 includes two or more types of light emitting elements having emission intensities that can be controlled independently and spectral distributions different from one another. The light emitting elements are typically LEDs corresponding to the three primary colors of RGB. Since the LEDs are small and lightweight, it is relatively easy to mount a plurality of LEDs in one lighting apparatus and control the emission intensity of each LED independently. Except for the LED, any other elements can be used as the light emitting elements, such as a fluorescent tube, a filament lamp, or sodium lamp. The combination of these elements may be used as the light emitting elements. The light source 130 may further be provided with a light diffuser plate for mixing colors of lights from plural light emitting elements.

The light source controller 120 controls the emission of each light emitting elements constituting the light source 130. Typically, the light source controller 120 controls the amount of current flowing through each light emitting elements. The light source controller 120 may control a voltage applied to each light emitting elements. A DC current and DC voltage may be controlled, or an AC current and AC voltage may be controlled. Any control method such as PWM control or phase control may be employed. The light source controller 120 holds therein a table of a value of a spectral distribution of each light emitting elements in the light source 130. If the number of the types of light emitting elements is n, this table stores values of each of Pᵢ(λ), (i=1, 2, n) at a predetermined interval within a region of a visible light. When the emission intensity of each of the light emitting elements is defined as aᵢ (i=1, 2, . . . , n), the light source controller 120 has a function of calculating the emission intensity P(λ) of the light source 130 according to Expression (1) described above.

The light source controller 120 also has a function of reporting the calculated P(λ) to the first calculator 680 and the second calculator 690. The light source controller 120 also has a function of receiving estimated values (first evaluation value and second evaluation value) calculated by the first calculator 680 and the second calculator 690, and solving an optimization problem having the estimated values defined as target variables.

The estimation unit 670 estimates a spectral reflectivity of an object (not illustrated) that is to be illuminated by the illumination light from the light source 130. FIG. 16 is a block diagram illustrating an example of a configuration of the estimation unit 670 according to the sixth embodiment. The configuration of the estimation unit 670 will be described below. The estimation unit 670 includes an imager 671, a variable filter 672, an imaging controller 673, and an image processor 674.

The imager 671 is an image sensor such as a COD camera or a CMOS camera. The spectral sensitivity S(λ) of the imager 671 has already been known. The imager 671 images an object, which is illuminated by the illumination light from the light source 130 through the variable filter 672, in synchronous with the variable filter 672 in accordance with the report from the imaging controller 673. The captured image is transmitted to the image processor 674. The variable filter 672 can change plural filters whose spectral transmittance has been known. The variable filter 672 changes the spectral transmittance in accordance with the report from the imaging controller 673. The spectral transmittance may be switched by rotation or movement of a plurality of physically different filters, or may be achieved by a liquid crystal tunable filter or the like that can be electrically controlled. Supposing that m types of spectral transmittances can be realized, each spectral transmittance is defined as Tᵢ(λ), (j=1, 2, . . . , m).

The imaging controller 673 controls the variable filter 672 and the imager 671 such that the variable filter 672 changes the spectral transmittance, and then, the imager 671 captures an image.

The image processor 674 estimates the spectral reflectivity of the object, which is illuminated by the illumination light from the light source 130, from plural images captured by the imager 671 under different spectral transmittances of the variable filter 672. The method of estimating the spectral reflectivity by the image processor 674 is as described below.

The spectral reflectivity on any portion of the object is defined as R(λ), the spectral power distribution of the light source 130 is defined as P(λ), the spectral sensitivity of the imager 671 is defined as S(λ), and the spectral transmittance that can be changed by the variable filter 672 is defined as Tⱼ(λ), (j=1, 2, . . . , m). The values of S(λ) and Tⱼ(λ) are held as a table (not illustrated) in the image processor 674, for example.

The output value Vⱼ of the imager 671 to the object, captured through the variable filter 672 whose spectral transmittance is changed to the jth spectral transmittance, is represented by Equation (6) described below.

Vⱼ=∫ₕ_{₁}^{h}^{_{w}}P(λ)R(λ)Tⱼ(λ)S(λ)dλ (6)

λ₁ and λ_{w} respectively indicate a lower limit and an upper limit of a wavelength where the sensitivity of the imager 671 is guaranteed. When the integration described above is approximated by a discrete value, and resolved, a determinant illustrated by Equation (7) is obtained. Here, Δλ is a quantization range for performing the discretization.

$$[ \begin{matrix}{V}_{1} \\ {V}_{2} \\ ⋮ \\ {V}_{m}\end{matrix} ] = [ \begin{matrix}P ( {λ}_{1} ) {T}_{1} ( {λ}_{1} ) S ( {λ}_{1} ) Δ λ & P ( {λ}_{2} ) {T}_{1} ( {λ}_{2} ) S ( {λ}_{2} ) Δ λ & … & P ( {λ}_{w} ) {T}_{1} ( {λ}_{w} ) S ( {λ}_{w} ) Δ λ \\ P ( {λ}_{1} ) {T}_{2} ( {λ}_{1} ) S ( {λ}_{1} ) Δ λ & P ( {λ}_{2} ) {T}_{2} ( {λ}_{2} ) S ( {λ}_{2} ) Δ λ & … & P ( {λ}_{w} ) {T}_{2} ( {λ}_{w} ) S ( {λ}_{w} ) Δ λ \\ ⋮ & ⋮ & ⋮ & ⋮ \\ P ( {λ}_{1} ) {T}_{m} ( {λ}_{1} ) S ( {λ}_{1} ) Δ λ & P ( {λ}_{2} ) {T}_{m} ( {λ}_{2} ) S ( {λ}_{2} ) Δ λ & … & P ( {λ}_{w} ) {T}_{m} ( {λ}_{w} ) S ( {λ}_{w} ) Δ λ\end{matrix} ] [ \begin{matrix}R ( {λ}_{1} ) \\ R ( {λ}_{2} ) \\ ⋮ \\ R ( {λ}_{w} )\end{matrix} ] \qquad ( 7 )$$

When the matrix at the left in the right side in Equation (7) is put as F, and a pseudo inverse matrix G of F is obtained by wiener method, the spectral reflectivity R(λ) of the object can be obtained by Equation (8) described below.

$$[ \begin{matrix}R ( {λ}_{1} ) \\ R ( {λ}_{2} ) \\ ⋮ \\ R ( {λ}_{w} )\end{matrix} ] = G [ \begin{matrix}{V}_{1} \\ {V}_{2} \\ ⋮ \\ {V}_{m}\end{matrix} ] \qquad ( 8 )$$

In the above description, the number of channels of the imager 671 is 1 (the monochromatic image). If the imager 671 having 3 channels of RGB is used, for example, the number of the equations in Equation (7) can be tripled. Therefore, the spectral reflectivity can be estimated with high precision.

Alternatively, the spectral power distribution of the light source 130 may be changed in synchronization with imaging. In this case, the spectral reflectivity of a certain part of the object is represented by R(λ), each of m different spectral distributions of the light source 130 is represented by Pⱼ(λ) (j=1, 2, . . . , m), and the spectral sensitivity of the imaging device is represented by S(λ). Accordingly, an output Vⱼ of the imaging device for the object captured under the light source having the j-th spectral distribution is expressed by the following Expression (9).

Vⱼ=∫ₕ_{₁}^{h}^{_{w}}Pⱼ(λ)R(λ)S(λ)dλ (9)

The integration is approximated as a discrete value and resolved to obtain a determinant as in the following Expression (10).

$$[ \begin{matrix}{V}_{1} \\ {V}_{2} \\ ⋮ \\ {V}_{m}\end{matrix} ] = [ \begin{matrix}{P}_{1} ( {λ}_{1} ) S ( {λ}_{1} ) Δ λ & {P}_{1} ( {λ}_{2} ) S ( {λ}_{2} ) Δ λ & … & {P}_{1} ( {λ}_{w} ) S ( {λ}_{w} ) Δ λ \\ {P}_{2} ( {λ}_{1} ) S ( {λ}_{1} ) Δ λ & {P}_{2} ( {λ}_{2} ) S ( {λ}_{2} ) Δ λ & … & {P}_{2} ( {λ}_{w} ) S ( {λ}_{w} ) Δ λ \\ ⋮ & ⋮ & ⋮ & ⋮ \\ {P}_{m} ( {λ}_{1} ) S ( {λ}_{1} ) Δ λ & {P}_{m} ( {λ}_{2} ) S ( {λ}_{2} ) Δ λ & … & {P}_{m} ( {λ}_{w} ) S ( {λ}_{w} ) Δ λ\end{matrix} ] [ \begin{matrix}R ( {λ}_{1} ) \\ R ( {λ}_{2} ) \\ ⋮ \\ R ( {λ}_{w} )\end{matrix} ] \qquad ( 10 )$$

If the left matrix on the right side in the Expression (10) is represented by F and a pseudo inverse matrix G of F is obtained by the Wiener method or the like, the spectral reflectivity R(λ) of the object can be obtained by the following Expression (11).

$$[ \begin{matrix}R ( {λ}_{1} ) \\ R ( {λ}_{2} ) \\ ⋮ \\ R ( {λ}_{w} )\end{matrix} ] = G [ \begin{matrix}{V}_{1} \\ {V}_{2} \\ ⋮ \\ {V}_{m}\end{matrix} ] \qquad ( 11 )$$

It is also possible to combine changing the spectral power distribution of the light source 130 and imaging by the variable filter 672. In this case, when the type of the variable filter 672 is represented by m₁ and the type of spectral distribution that varies according to the light source 130 is represented by m₂, the number of equations in the Expression (10) can be up to m₁×m₂ and it is possible to estimate the spectral reflectivity of the object with higher accuracy.

The second calculator 690 estimates a non-visual influence quantity Y1 of the illumination based on the spectral power distribution P(λ) of the light source 130 reported from the light source controller 120. The estimated non-visual influence quantity Y1 is reported to the light source controller 120. The estimation value of the second calculator 690 is either of the value obtained by integration of a product of a melatonin secretion inhibiting spectrum and the spectral power distribution of the light source 130 or the value of a prediction formula for melatonin secretion inhibition taking responses of cones, rods and ganglion cells containing melanopsin into account described with reference to the Expression (2) to the Expression (5).

The first calculator 680 calculates the output value (first evaluation value) indicating an adequacy of a color of an object (color appearance of an object) visually perceived, based on the spectral power distribution of the light source 130 and the spectral reflectivity of the object. For example, the first calculator 680 estimates the color appearance of the object under a standard light source based on the value R(λ), estimated by the estimation unit 670, of the spectral reflectivity of the object illuminated by the illumination light from the light source 130, and the value P(λ) of the spectral power distribution of the light source 130 determined by the light source controller 120. The specific method of the estimation will be described below.

Firstly, the first calculator 680 obtains a correlated color temperature of emission color by the spectral power distribution P(λ) of the light source 130, and determines the light source used as the standard light source. When the correlated color temperature of P(λ) is less than 5000 K, the first calculator 680 defines light with the correlated color temperature equal to P(λ) of a complete radiator as the standard light source. When it is 5000 K or more, the first calculator 680 defines light with the correlated color temperature equal to P(λ) of CIE daylight as the standard light source. The value of the spectral power distribution of the standard light source obtained here is defined as S(λ) below. This value is stored as a table (not illustrated) in the first calculator 680, for example.

A coordinate value (Xₚ, Yₚ, Zₚ) corresponding to the light source 130 in an XYZ color system and a coordinate value (Xₛ, Yₛ, Zₛ) corresponding to the standard light source are obtained by Equation (12) to Equation (19) described below.

$$\begin{matrix}{X}_{p} = {K}_{p} {\int }_{380 nm}^{780 nm} P ( λ ) \dot{x} ( λ ) d λ & ( 12 ) \\ {Y}_{p} = {K}_{p} {\int }_{380 nm}^{780 nm} P ( λ ) \dot{y} ( λ ) d λ & ( 13 ) \\ {Z}_{p} = {K}_{p} {\int }_{380 nm}^{780 nm} P ( λ ) \dot{z} ( λ ) d λ \\ wherein & ( 14 ) \\ {K}_{p} = \frac{100}{{\int }_{380 nm}^{780 nm} P ( λ ) \dot{y} ( λ ) d λ} & ( 15 ) \\ {X}_{s} = {K}_{s} {\int }_{380 nm}^{780 nm} S ( λ ) \dot{x} ( λ ) d λ & ( 16 ) \\ {Y}_{s} = {K}_{s} {\int }_{380 nm}^{780 nm} S ( λ ) \dot{y} ( λ ) d λ & ( 17 ) \\ {Z}_{s} = {K}_{s} {\int }_{380 nm}^{780 nm} S ( λ ) \dot{z} ( λ ) d λ \\ wherein & ( 18 ) \\ {K}_{s} = \frac{100}{{\int }_{380 nm}^{780 nm} S ( λ ) \dot{y} ( λ ) d λ} & ( 19 )\end{matrix}$$

wherein \dot{x}(λ), \dot{y}(λ) and ż(λ) are color-matching functions in the XYZ color system.

Next, a coordinate value (uₚ, vₚ) corresponding to the light source 130 on a CIE1960UCS chromaticity diagram and a coordinate value (uₛ, vₛ) corresponding to the standard light source are obtained by Equation (20) to Equation (23) described below.

$$\begin{matrix}{u}_{s} = \frac{4 {X}_{s}}{{X}_{s} + 15 {Y}_{s} + 3 {Z}_{s}} & ( 20 ) \\ {v}_{s} = \frac{6 {Y}_{s}}{{X}_{s} + 15 {Y}_{s} + 3 {Z}_{s}} & ( 21 ) \\ {u}_{p} = \frac{4 {X}_{p}}{{X}_{p} + 15 {Y}_{p} + 3 {Z}_{p}} & ( 22 ) \\ {v}_{p} = \frac{6 {Y}_{p}}{{X}_{p} + 15 {Y}_{p} + 3 {Z}_{p}} & ( 23 )\end{matrix}$$

A value (Xₚᵣ, Yₚᵣ, Zₚᵣ) Of a tristimulus value of an object color under the light source 130 and a value (Xₛᵣ, Yₛᵣ, Zₛᵣ) thereof under the standard light source are obtained by Equation (24) to Equation (31) described below.

$$\begin{matrix}{X}_{sr} = {K}_{p} {\int }_{380 nm}^{780 nm} S ( λ ) R ( λ ) \dot{x} ( λ ) d λ & ( 24 ) \\ {Y}_{sr} = {K}_{p} {\int }_{380 nm}^{780 nm} S ( λ ) R ( λ ) \dot{y} ( λ ) d λ & ( 25 ) \\ {Z}_{sr} = {K}_{p} {\int }_{380 nm}^{780 nm} S ( λ ) R ( λ ) \dot{z} ( λ ) d λ & ( 26 ) \\ {K}_{sr} = \frac{100}{{\int }_{380 nm}^{780 nm} S ( λ ) R ( λ ) \dot{y} ( λ ) d λ} & ( 27 ) \\ {X}_{pr} = {K}_{p} {\int }_{380 nm}^{780 nm} P ( λ ) R ( λ ) \dot{x} ( λ ) d λ & ( 28 ) \\ {Y}_{pr} = {K}_{p} {\int }_{380 nm}^{780 nm} P ( λ ) R ( λ ) \dot{y} ( λ ) d λ & ( 29 ) \\ {Z}_{pr} = {K}_{p} {\int }_{380 nm}^{780 nm} P ( λ ) R ( λ ) \dot{z} ( λ ) d λ \\ wherein & ( 30 ) \\ {K}_{pr} = \frac{100}{{\int }_{380 nm}^{780 nm} P ( λ ) R ( λ ) \dot{y} ( λ ) d λ} & ( 31 )\end{matrix}$$

From these values, a coordinate value (uₚᵣ, vₚᵣ) under the light source 130 on the CIE1960UCS chromaticity diagram and a coordinate value (uₛᵣ, vₛᵣ) under the standard light source are obtained by Equation (32) to Equation (35) described below.

$$\begin{matrix}{u}_{sr} = \frac{4 {X}_{sr}}{{X}_{sr} + 15 {Y}_{sr} + 3 {Z}_{sr}} & ( 32 ) \\ {v}_{sr} = \frac{6 {Y}_{sr}}{{X}_{sr} + 15 {Y}_{sr} + 3 {Z}_{sr}} & ( 33 ) \\ {u}_{pr} = \frac{4 {X}_{pr}}{{X}_{pr} + 15 {Y}_{pr} + 3 {Z}_{pr}} & ( 34 ) \\ {v}_{pr} = \frac{6 {Y}_{pr}}{{X}_{pr} + 15 {Y}_{pr} + 3 {Z}_{pr}} & ( 35 )\end{matrix}$$

Next, a chromatic-adaptation transform is executed in accordance with Equation (36) to Equation (39) described below.

$$\begin{matrix}{u}_{p}^{′} = {u}_{s} & ( 36 ) \\ {v}_{p}^{′} = {v}_{s} & ( 37 ) \\ {u}_{pr}^{′} = \frac{10.872 + 0.404 \frac{{c}_{s}}{{c}_{p}} {c}_{pr} - 4 \frac{{d}_{s}}{{d}_{p}} {d}_{pr}}{16.518 + 1.481 \frac{{c}_{s}}{{c}_{p}} {c}_{pr} - 4 \frac{{d}_{s}}{{d}_{p}} {d}_{pr}} & ( 38 ) \\ {v}_{pr}^{′} = \frac{5.520}{16.518 + 1.481 \frac{{c}_{s}}{{c}_{p}} {c}_{pr} - 4 \frac{{d}_{s}}{{d}_{p}} {d}_{pr}} & ( 39 )\end{matrix}$$

Here, cₛ, cₚ, cₚᵣ, dₛ, dₚ, and dₚᵣ are obtained by Equation (40) to Equation (45) described below.

$$\begin{matrix}{c}_{s} = \frac{1}{{v}_{s}} ( 4.0 - {u}_{s} - 10.0 {v}_{s} ) & ( 40 ) \\ {c}_{p} = \frac{1}{{v}_{p}} ( 4.0 - {u}_{p} - 10.0 {v}_{p} ) & ( 41 ) \\ {c}_{pr} = \frac{1}{{v}_{pr}} ( 4.0 - {u}_{pr} - 10.0 {v}_{pr} ) & ( 42 ) \\ {v}_{s} = \frac{1}{{v}_{s}} ( 1.708 {v}_{s} + 0.404 - 1.481 {u}_{s} ) & ( 43 ) \\ {v}_{p} = \frac{1}{{v}_{p}} ( 1.708 {v}_{p} + 0.404 - 1.481 {u}_{p} ) & ( 44 ) \\ {v}_{pr} = \frac{1}{{v}_{pr}} ( 1.708 {v}_{pr} + 0.404 - 1.481 {u}_{pr} ) & ( 45 )\end{matrix}$$

A coordinate (W^{*}ₛᵣ, U*ₛᵣ, V^{*}ₛᵣ) under the standard light source in a CIE1964 uniform color space and a coordinate (W*ₚᵣ, U*ₚᵣ, V*ₚᵣ) under the light source 130 are obtained by Equation (46) to Equation (51) described below.

$$\begin{matrix}{W}_{sr}^{*} = 25 {( {Y}_{sr} )}^{\frac{1}{3}} - 17 & ( 46 ) \\ {U}_{sr}^{*} = 13 {W}_{sr}^{*} ( {u}_{sr} - {u}_{s} ) & ( 47 ) \\ {V}_{sr}^{*} = 13 {W}_{sr}^{*} ( {v}_{sr} - {v}_{s} ) & ( 48 ) \\ {W}_{pr}^{*} = 25 {( {Y}_{pr} )}^{\frac{1}{3}} - 17 & ( 49 ) \\ {U}_{pr}^{*} = 13 {W}_{pr}^{*} ( {u}_{pr}^{′} - {u}_{p}^{′} ) & ( 50 ) \\ {V}_{pr}^{*} = 13 {W}_{pr}^{*} ( {v}_{pr}^{′} - {v}_{p}^{′} ) & ( 51 )\end{matrix}$$

A chromaticity difference ΔE is obtained by Equation (52) described below through the procedure described above.

$$Δ E = \sqrt{{( {W}_{sr}^{*} - {W}_{pr }^{*} )}^{2} + {( {U}_{sr}^{*} - {U}_{pr }^{*} )}^{2} + {( {V}_{sr}^{*} - {V}_{pr }^{*} )}^{2}} \qquad ( 52 )$$

The value of ΔE is obtained for each pixel of the image captured by the imager 671. Therefore, the value of each pixel is defined as ΔE_{hw} (h=1, 2, . . . , H) (w=1, 2, . . . , W), and the total of the chromaticity difference of the whole image is specified as farness in color appearance under two illuminations.

$$Δ {E}_{sum} = {\sum }_{h = 1}^{H} {\sum }_{w = 1}^{W} Δ {E}_{hw} \qquad ( 53 )$$

In Equation (53), the values are summed up over the whole region of the image. However, only the values in a specific region may be considered into.

A closeness in the color appearance can be defined by any function Y2=F(ΔEₛᵤₘ), wherein Y2 becomes smaller as the value of ΔEₛᵤₘ increases. The value Y2 of the closeness in the color appearance becomes the output value (first evaluation value) of the first calculator 680.

The method described above is a method of calculating the color appearance under the standard light source in the CIE1964 uniform color space and the closeness in the color appearance under the light source 130 of the illumination device 600. This method can be replaced by a method of obtaining a chromaticity difference in another color space such as L*a*b* color space. Alternatively, an equation of chromaticity difference such as CIEDE2000 can be used instead.

The light source controller 120 also has a function of solving an optimization problem for the estimation result Y2 of the first calculator 680 and the estimation result Y1 of the second calculator 690 and determining the emission intensity aᵢ of each light emitting element of the light source 130. The spectral power distribution P(λ) of the light source 130 is determined by the Expression (1) described above using the emission intensity aᵢ of each of the light emitting elements constituting the light source 130. Since both of the estimation result Y2 of the first calculator 680 and the estimation result Y1 of the second calculator 690 are values determined by P(λ), the problem of optimization by providing certain constraint conditions on Y1 and Y2 with aᵢ is a typical numerical optimization problem and can be solved by techniques such as the gradient method and the simulated annealing method.

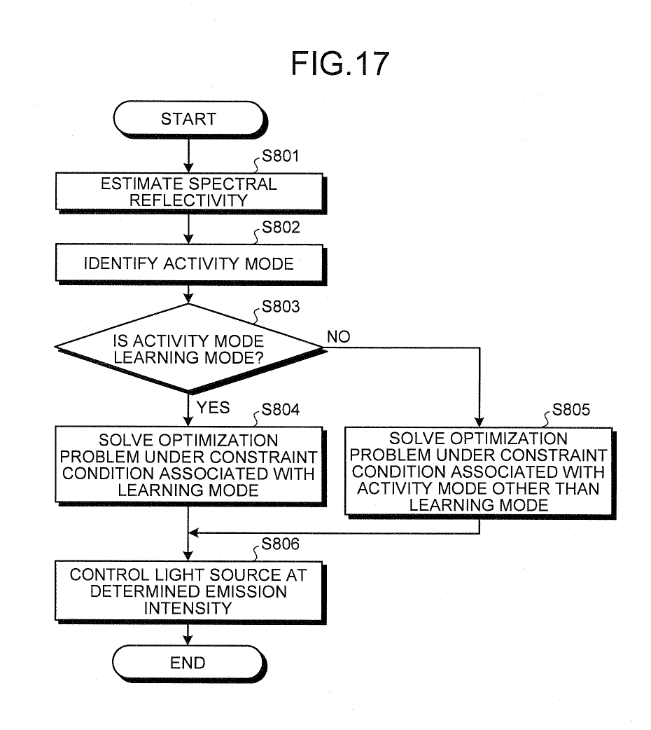

Next, a control process performed by the illumination device 600 according to the sixth embodiment will be described with reference to FIG. 17. FIG. 17 is a flowchart illustrating an example of a flow of the control process according to the sixth embodiment.

As illustrated in FIG. 17, for example, the estimation unit 670 estimates the spectral reflectivity of an object irradiated with illumination (step S801). The estimation result is notified to the first calculator 680. The identifying unit 110 identifies the activity mode of the user (step S802).

If the light source controller 120 determines that the activity mode identified by the identifying unit 110 is the learning mode (Yes in step S803), the light source controller 120 optimizes the emission intensity aᵢ of each light emitting element of the light source 130 under a constraint condition associated with the learning mode (step S804). The constraint condition under which the optimization is performed is a condition in which the estimation value Y1 of the second calculator 690 is kept to a certain value X_{1L} or lower and the estimation value Y2 of the first calculator 680 is maximized.

If the light source controller 120 determines that the activity mode identified by the identifying unit 110 is an activity mode other than the learning mode (No in step S803), on the other hand, the light source controller 120 optimizes the emission intensity aᵢ of each light emitting element of the light source 130 under a constraint condition associated with the activity mode other than the learning mode (step S805). The constraint condition under which the optimization is performed is a condition in which the estimation value Y1 of the second calculator 690 is kept to a certain value X_{1N} or lower and the estimation value Y2 of the first calculator 680 is maximized. The light source controller 120 then controls the emission intensity of the light emitting elements of the light source 130 on the basis of the determined values of the emission intensity aᵢ (step S806).

It is assumed here that the relation between X_{1L} and X_{1N} satisfies X_{1L}<X_{1N}. In other words, the optimization problem is solved under the constraint condition that the level of arousal is set lower in the case of the learning mode and the emission intensity is determined thereby.

Alternatively, the constraint condition in step S804 may be replaced with a condition in which the estimation result Y2 of the first calculator 680 is kept to a certain value X_{2L} or larger and Y1 is minimized. Similarly, the constraint condition in step S805 may be replaced with a condition in which the estimation result Y2 of the first calculator 680 is kept to a certain value X_{2N} or larger and Y1 is minimized. It is assumed here that the relation between X_{2L} and X_{2N} satisfies X_{2L}<X_{2N}. Since making Y1 smaller and making Y2 larger are contradictory, optimization under the constraint conditions described above results in setting the level of arousal lower with the illumination light in the learning mode.

According to the sixth embodiment, it is possible to control the light source so that the level of arousal of the user is low when the activity of the user is a learning activity and to keep the color appearance of an object irradiated with the illumination close to the color appearance under the standard light source.

### Modified Example of Sixth Embodiment

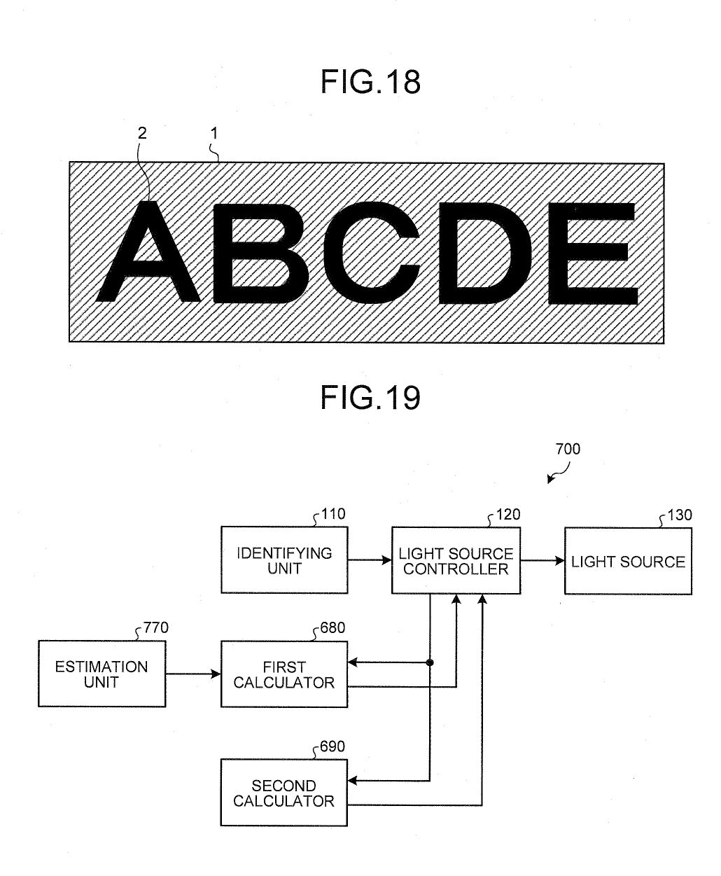

FIG. 18 is a diagram illustrating an example of an object illuminated with illumination light containing a plurality of colors. As illustrated in FIG. 18, for example, characters 2 having a spectral reflectivity of R_{B}(λ) are written on a background 1 having a spectral reflectivity of R_{A}(λ). If the chromaticity difference of the colors perceived in the region of the background 1 and the region of the characters 2 is sufficiently great, the characters 2 can be read even if the colors are greatly shifted from the colors perceived under the standard light source.

Specifically, the value of Y2 used for obtaining the aᵢ by solving the above-mentioned optimization problem may be replaced by a chromaticity difference in plural regions, each having different spectral reflectivity. For this replacement, what is done in the first calculator 680 is replaced as described below in the present modification.

Firstly, a cluster analysis is performed to the value R(λ) of the spectral reflectivity of each pixel estimated by the estimation unit 670. With this process, the value R(λ) of the spectral reflectivity is classified into a cluster belonging to each region. The values of the spectral reflectivity corresponding to the representative values (e.g., centroids) of the first region and the second region are set as R₁(λ) and R₂(λ).

The coordinate in the CIE1964 uniform color space under the light source 130 can be calculated in the same manner as in the above-mentioned method. The coordinate of the first region is set as (W*ₚᵣ₁, U*ₚᵣ₁, V*ₚᵣ₁), and the coordinate of the second region is set as (W*ₚᵣ₂, U*ₚᵣ₂, V*ₚᵣ₂).

The chromaticity difference ΔE12 between the first region and the second region can be obtained by Equation (54) described below. This value can be set as the output value Y2 of the first calculator 680.

$$Δ {E}_{12} = \sqrt{{( {W}_{pr 1}^{*} - {W}_{pr 2}^{*} )}^{2} + {( {U}_{pr 1}^{*} - {U}_{pr 2}^{*} )}^{2} + {( {V}_{pr 1}^{*} - {V}_{pr 2}^{*} )}^{2}} \qquad ( 54 )$$

In this modification, the method of obtaining the chromaticity difference in the CIE1964 uniform color space can be replaced by a method of obtaining a chromaticity difference in another color space such as L*a*b* color space. Alternatively, an equation of chromaticity difference such as CIEDE2000 can be used instead.

The above-mentioned process is for the case in which there are two regions, each having a different spectral reflectivity. However, the similar process can be applied to the case in which there are three or more regions. In this case, the chromaticity difference may be calculated for each combination of the respective regions, and its average or minimum value may be set as the output value of the first calculator 680.

For example, when characters (reflecting generally wavelengths of red, green and blue) that look white under the white light source are written on a background (that hardly reflects light of all wavelengths) that looks black under the white light source, the characters look yellow, which is very far from black, even if the light source 130 does not contain blue light, because the character region reflects light having wavelengths of red and green. Therefore, the value of Y2 can be kept large without the inclusion of the blue light that gives a great non-visual influence. Thus, according to this modified example, the level of arousal can be more efficiently lowered.

The case between the background color and the character color is described above. However, the modification is applicable for a case except for the case between the background and characters, e.g., for a case in which different colors can be distinguished (e.g., a color-coded map).

### Seventh Embodiment

FIG. 19 is a block diagram illustrating an exemplary configuration of an illumination device 700 according to a seventh embodiment. In FIG. 19, the functional units that perform processes similar to those in the sixth embodiment will be designated by the same reference numerals and the description of the same processes may not be repeated.

As illustrated in FIG. 19, for example, the illumination device 700 includes an identifying unit 110, a light source controller 120, a light source 130, an estimation unit 770, a first calculator 680 and second calculator 690.

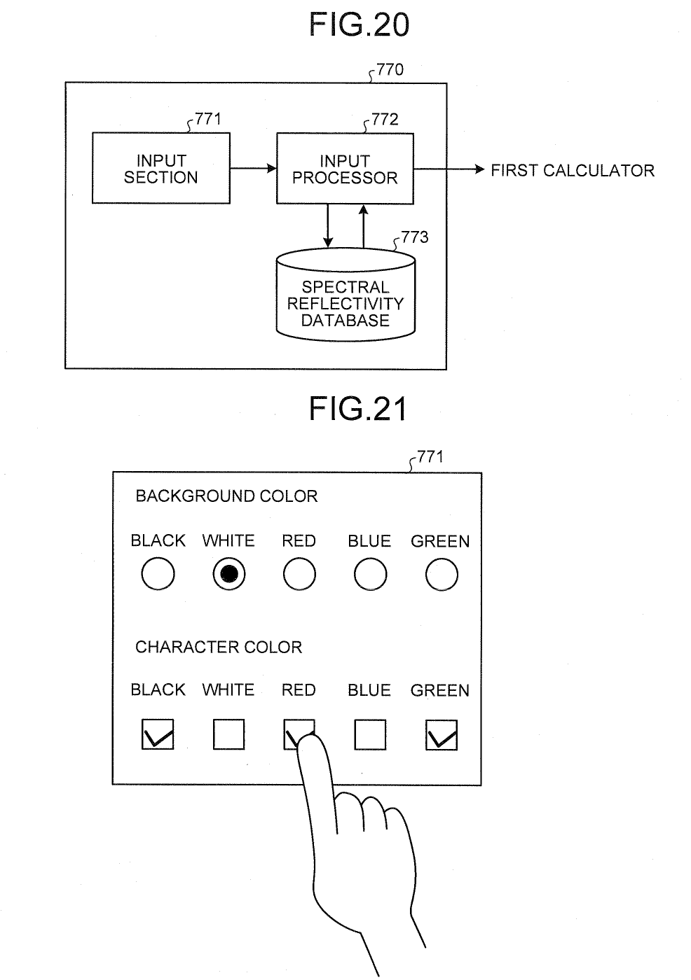

FIG. 20 is a block diagram illustrating an exemplary configuration of the estimation unit 770 according to the seventh embodiment. For example, the estimation unit 770 includes an input section 771, an input processor 772, and a spectral reflectivity database 773.

The input section 771 is composed of a touch panel display, for example. FIG. 21 is a diagram illustrating an exemplary configuration of the input section 771 according to the seventh embodiment. As illustrated in FIG. 21, the user uses the input section 771 to select a color used for an object (e.g., a book) illuminated by the illumination. The information selected in the input section 771 is reported to the input processor 772. The input section 771 may be composed of a physical button or the like, instead of the touch panel display.

The input processor 772 estimates a spectral reflectivity with reference to the spectral reflectivity database 773 based on the information reported from the input section 771. The result of the estimation is reported to the first calculator 680.

The spectral reflectivity database 773 is a storage unit that stores spectral reflectivity of a typical (average) sheet or ink for each color, for example. The spectral reflectivity database 773 can be composed of a storage medium popularly used, such as HDD (Hard Disk Drive), an optical disk, a memory card, and a RAM (Random Access Memory).

The spectral reflectivity database 773 transmits the value of the spectral reflectivity P(λ) corresponding to each color to the input processor 772 in accordance with the inquiry from the input processor 772. The spectral reflectivity database 773 may be present on external network such as Web. In this case, the input processing unit 306 has a function of connecting to the network.

With this configuration, the estimation unit 770 in the seventh embodiment can estimate the spectral reflectivity of the object. The seventh embodiment can realize functions like those of the sixth embodiments without mounting a high-cost camera (imager) or variable filter to the estimation unit 770.

### Modified Example of Seventh Embodiment

In this modified example, the user specifies the name of an object irradiated with illumination instead of directly specifying the color of the object irradiated with illumination.

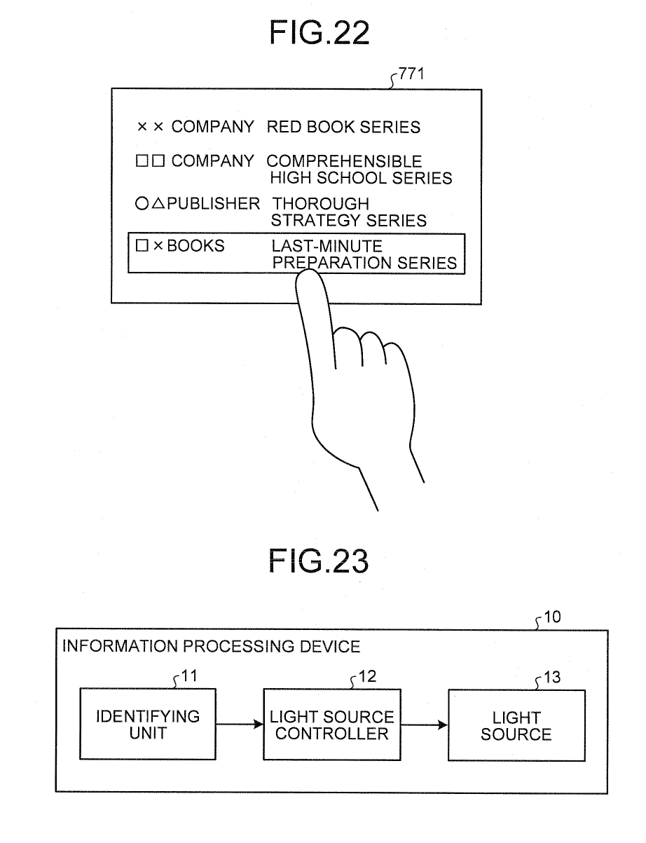

FIG. 22 is a diagram illustrating an exemplary configuration of the input section 771 according to a modified example of the seventh embodiment. As illustrated in FIG. 22, for example, the input section 771 is a touch panel display that allows the user to select a proper name or a general name of an object irradiated with illumination. As an example other than the form of specifying a specific publishing series as illustrated in FIG. 22, the specification may be made at such a granularity as “textbook”, “study guide” and “handout”. Alternatively, it may be configured such that an input of a specific book name or an ISBN code that can identify a book is entered, or that an input is made by using a bar-code reader, a camera, or the like.

The spectral reflectivity database 773 stores spectral reflectivity for the sheet and each color of ink used for the object designated by the input section 771. The spectral reflectivity database 773 transmits the spectral reflectivity P(λ) corresponding to each of the used colors to the input processor 772 in accordance with the inquiry from the input processor 772. The spectral reflectivity database 773 may be provided or may be present on external network such as Web. The spectral reflectivity database 773 can be configured such that, when a new magazine is first published, or when a used sheet or a type of used ink is changed, the content thereof can be updated on a case-by-case basis.

The present modification can spare the user the trouble of designating the color of the object illuminated by the illumination. Since the spectral reflectivity of the actual object can be used, the spectral power distribution of the light source can be optimized based on the highly-precise spectral reflectivity.

As described above, the sixth and seventh embodiments can evaluate a color appearance of an object, which is illuminated by illuminating light from the light source, in consideration of the spectral reflectivity of the object, in order to prevent light with a wavelength unnecessary for keeping the color appearance of the object from being contained in the illuminating light. As a result, the level of arousal can be more efficiently lowered.

### Other Embodiments

FIG. 23 is a block diagram illustrating an exemplary configuration of an information processing device. As illustrated in FIG. 23, for example, an information processing device 10 includes an identifying unit 11, a light source controller 12 and a light source 13. Among these components, the light source 13 is provided on a back face of a display mounted on the information processing device 10, for example. Since the processes performed by the identifying unit 11, the light source controller 12 and the light source 13 are similar to those in the embodiments described above, the description thereof will not be repeated. Thus, in one aspect, the identifying unit 11 performs processes such as specifying an activity of the user on the basis of a type of an application run on the information processing device 10 by the user.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An illumination device comprising:
a light source whose emission intensity is controllable;
an identifying unit configured to identify an activity of a user; and
a light source controller configured to control the emission intensity of the light source so that a level of arousal of the user becomes lower than a predetermined level when the identified activity is a learning activity representing an activity to form a memory in the brain of the user.

2. The device according to claim 1, further comprising a memory configured to hold history information indicating that the user has performed the learning activity, wherein
the identifying unit identifies the activity of the user as the learning activity when the history information is held in the memory.

3. The device according to claim 1, further comprising a memory configured to hold history information indicating that the user has performed the learning activity, wherein
the light source controller controls the emission intensity of the light source so that the level of arousal of the user becomes lower than the predetermined level when the identified activity is not the learning activity and when the history information is held in the memory.

4. The device according to claim 1, wherein
the light source configured to include plural light emitting elements, each having a different spectral distributions,
the device further comprises:
an estimation unit configured to estimate a spectral reflectivity of an object to which illumination light is irradiated from the light source;
a first calculator configured to calculate a first evaluation value, indicating an adequacy of a color of the object visually perceived, based on the spectral distributions and the spectral reflectivity; and
a second calculator configured to calculate a second evaluation value, indicating how much an influence is given by the illumination light to factors other than a visual sense, based on the spectral distributions,
wherein the light source controller determines the emission intensity by which the first evaluation value and the second evaluation value satisfy a restraint condition determined beforehand, and control the light emitting elements to have the determined emission intensity.

5. The device according to claim 4, wherein the first evaluation value is a magnitude in a difference in appearances among plural regions included in the object.

6. The device according to claim 4, wherein the restraint condition is a condition in which the second evaluation value decreases with the first evaluation value being kept to be not less than a predetermined fixed value, or a condition in which the second evaluation value increases with the first evaluation value being kept to be not less than the fixed value.

7. The device according to claim 4, wherein the second evaluation value is an integral of a product of the spectral distributions of the light source and a action spectrum for meratonin suppression, or a value of a melatonin secretory inhibition prediction expression based on the responses of a cone, a rod, and a melanopsin-containing ganglion cell.

8. The device according to claim 4, wherein the estimation unit includes:
an imager configured to capture an image of the object; and
an image processor configured to estimate the spectral reflectivity based on the image and the spectral distributions of the light source.

9. The device according to claim 8, wherein
the imager captures an image of the object through a variable filter of which spectral transmittance is changeable, and
the image processor estimates the spectral reflectivity based on the plural images, which are captured through the variable filter that is changed to the different spectral transmittances, and the spectral distributions of the light source.

10. The device according to claim 4, wherein the estimation unit includes
an input processor configured to accept an input value according to the spectral reflectivity, and estimate the spectral reflectivity according to the input value.

11. The device according to claim 1, further comprising an identification information receiving unit configured to receive, from an external device, identification information capable of identifying a type of an application run on the external device by the user, wherein
the identifying unit identifies the activity of the user on the basis of the identification information.

12. The device according to claim 1, further comprising a history information receiving unit configured to receive, from an external terminal, history information indicating that the user has performed the learning activity, wherein
the identifying unit identifies the activity of the user on the basis of the history information.

13. The device according to claim 1, wherein the identifying unit receives book information identifying a book used by the user, obtains a type of the book associated with the received book information from a storage that stores therein the type of the book and the book information in association with each other, and identifies the activity of the user on the basis of the obtained type of the book.

14. The device according to claim 1, wherein the light source controller controls the emission intensity of the light source so that the level of arousal of the user becomes lower than the predetermined level in the case of the learning activity and a predetermined time period.

15. An information processing device comprising:
a display;
a light source that is provided on a back face of the display and whose emission intensity is controllable;
an identifying unit configured to identify an activity of a user; and
a light source controller configured to control the emission intensity of the light source so that a level of arousal of the user becomes lower than a predetermined level when the identified activity is a learning activity representing an activity to form a memory in the brain of the user.

16. The device according to claim 15, wherein the identifying unit identifies the activity of the user on the basis of a type of an application run on the information processing device by the user.
